(19) United States
(12) Patent Application Publication
(10) Pub. No.: US 2019/0197071 A1
(43) Pub. Date: Jun. 27, 2019

(54) SYSTEM AND METHOD FOR EVALUATING NODES OF FUNNEL MODEL

(71) Applicant: ALIBABA GROUP HOLDING LIMITED, Grand Cayman (KY)

(72) Inventor: Yuxiang HU, Hangzhou (CN)

(21) Appl. No.: 16/286,522

(22) Filed: Feb. 26, 2019

Related U.S. Application Data
(63) Continuation of application No. PCT/CN2017/098752, filed on Aug. 24, 2017.

(30) Foreign Application Priority Data
Aug. 31, 2016 (CN) 201610798815.8

(51) Int. Cl. G06F 16/9535; G06F 16/954; G06F 16/958; G06F 16/955; G06F 16/957

(52) U.S. Cl. CPC G06F 16/9535; G06F 16/954; G06F 16/957; G06F 16/9566; G06F 16/958

(57) ABSTRACT

Embodiments of the disclosure provide methods and apparatuses for evaluating nodes of a funnel model. The method may include: acquiring browsing records of users, the browsing records including browsing paths of the users; and performing real-time evaluation on the nodes of the funnel model according to the acquired browsing paths of the users, wherein the acquired browsing paths are stored offline.

### CROSS REFERENCE TO RELATED APPLICATIONS

The disclosure claims the benefits of priority to International Application Number PCT/CN2017/098752, filed Aug. 24, 2017, which claims priority to Chinese Application Number 201610798815.8, filed Aug. 31, 2016, both of which are incorporated herein by reference in their entireties.

### BACKGROUND

In website operations, statistics on user access can be modeled as a funnel model. A funnel model typically includes at least two nodes (or levels), each node corresponding to a page (e.g., a web page). Parameters of the nodes of a funnel model can be acquired to evaluate the nodes of the funnel model. The parameters of a node can include, for example, the number of page views (PV) of the page corresponding to the node, the number of unique visitors (UV) of the page corresponding to the node, and the like. Node setup can be analyzed for nodes of the funnel model based on these parameters.

Conventionally, event tracking can be performed on a page corresponding to each node to collect a browsing record of each browsing action on the page. Each browsing action by a user for a page can generate a browsing record, and each browsing record can include a user identifier (e.g., cookie_ID) to differentiate different browsing users, a page number (page_ID), the page number of a navigation page for the current page (e.g., refer_page_ID), a web address of a browsed page (e.g., Uniform Resource Locator (URL)). The page number can be refreshed every time when the page is refreshed. The numbering of a navigation page for the current page is the page number of the page browsed prior to browsing the current page.

When each node of a funnel model is evaluated, parameters of each node of the funnel model can be acquired sequentially in an order of the nodes of the funnel model.

For example, parameters of a first node can be acquired. For example, a first set of browsing records having the same URL as the URL of the first node can be acquired. The number of browsing records in the first set can be the PV number of the first node, and the number of different cookie_IDs in the browsing records in the first set can be the UV number of the first node.

Then, parameters of a second node can be acquired. For example, a second set of browsing records having the same URL as the URL of the second node can be acquired. A third set of browsing records can be acquired from the second set, where each of the third set of browsing records has a refer_page_ID that is the same as a page_ID of a browsing record in the first set of browsing records. The number of browsing records in the third set is the PV number of the second node, and the number of different cookie_IDs in the browsing records in the third set is the UV number of the second node.

Then, parameters of subsequent nodes can be acquired. For example, parameters of a third node can be acquired. A fourth set of browsing records having the same URL as the URL of the third node can be acquired. A fifth set of browsing records can be acquired that from browsing records in the fourth set, where each of the fifth set of browsing records has a refer_page_ID that is the same as a page_ID of a browsing record in the third set of browsing records. The number of browsing records in the fifth set of browsing records is the PV number of the third node, and the number of different cookie_IDs in the browsing records in the fifth set of browsing records is the UV number of the third node.

The same process can be repeated until parameters of a last node of the funnel model are acquired. It can be seen that in the conventional method of evaluating nodes of a funnel model, parameters of each node of the funnel model are acquired sequentially in an order of the nodes of the funnel model, reducing the efficiency of evaluating nodes of a funnel model.

### SUMMARY OF THE DISCLOSURE

The present disclosure provides a system, a method, and an apparatus for evaluating nodes of a funnel model, so as to improve the efficiency of evaluating nodes of a funnel model.

Embodiments of the disclosure provide a system for evaluating nodes of a funnel model. The system can include: a memory storing a set of instruction; and at least one processor configured to execute the set of instructions to cause the system to perform: acquiring browsing records of users, the browsing records including browsing paths of the users; and performing real-time evaluation on the nodes of the funnel model according to the acquired browsing paths of the users, wherein the acquired browsing paths are stored offline.

Embodiments of the disclosure also provide a method for evaluating nodes of a funnel model. The method can include: acquiring browsing records of users, the browsing records including browsing paths of the users; and performing real-time evaluation on the nodes of the funnel model according to the acquired browsing paths of the users, wherein the acquired browsing paths are stored offline.

Embodiments of the disclosure further provide a non-transitory computer readable medium that stores a set of instructions that is executable by at least one processor of a computer system to cause the computer system to perform a method for evaluating nodes of a funnel model. The method can include: acquiring browsing records of users, the browsing records including browsing paths of the users; and performing real-time evaluation on the nodes of the funnel model according to the acquired browsing paths of the users, wherein the acquired browsing paths are stored offline.

### BRIEF DESCRIPTION OF THE DRAWINGS

The accompanying drawings, which are incorporated in and constitute part of this disclosure, together with the description, illustrate and serve to explain the principles of various example embodiments.

FIG. 1 illustrates a schematic diagram of a funnel model, according to embodiments of the present disclosure.

FIG. 2 illustrates a schematic diagram of a node definition, according to embodiments of the present disclosure.

FIG. 3A illustrates a schematic diagram of an exemplary screened path, according to embodiments of the present disclosure.

FIG. 3B illustrates a schematic diagram of another exemplary screened path, according to embodiments of the present disclosure.

FIG. 3C illustrates a schematic diagram of yet another exemplary screened path, according to embodiments of the present disclosure.

FIG. 3D illustrates a schematic diagram of still another exemplary screened path, according to embodiments of the present disclosure.

FIG. 4 illustrates a schematic diagram of a screened path, according to embodiments of the present disclosure.

FIG. 5 is a block diagram of an exemplary evaluation system for nodes of a funnel model, according to embodiments of the present disclosure.

FIG. 6 illustrates a flow chart of an exemplary method for acquiring a user browsing path, according to embodiments of the present disclosure.

FIG. 7 illustrates a flow chart of an exemplary method for acquiring parameters of nodes of a funnel model, according to embodiments of the present disclosure.

FIG. 8 illustrates a flow chart of an exemplary method for obtaining a conversion rate of a node of a funnel model, according to embodiments of the present disclosure.

FIG. 9 illustrates a flow chart of an exemplary method for evaluating a node of a funnel model, according to embodiments of the present disclosure.

FIG. 10 illustrates a block diagram an exemplary apparatus for acquiring a user browsing path, according to embodiments of the present disclosure.

FIG. 11 illustrates a block diagram of an exemplary apparatus for acquiring parameters of nodes of a funnel model, according to embodiments of the present disclosure.

FIG. 12 illustrates a block diagram of an exemplary apparatus for obtaining a conversion rate of a node of a funnel model, according to embodiments of the present disclosure.

FIG. 13 illustrates a block diagram of an apparatus for evaluating a node of a funnel model, according to embodiments of the present disclosure.

FIG. 14 illustrates a block diagram of another exemplary apparatus for acquiring a user browsing path, according to embodiments of the present disclosure.

FIG. 15 illustrates a block diagram of another exemplary apparatus for acquiring parameters of nodes of a funnel model, according to embodiments of the present disclosure.

FIG. 16 illustrates a block diagram of another exemplary apparatus for obtaining a conversion rate of a node of a funnel model, according to embodiments of the present disclosure.

FIG. 17 illustrates a block diagram of another exemplary apparatus for evaluating a node of a funnel model, according to embodiments of the present disclosure.

### DETAILED DESCRIPTION

The present disclosure provides a system, a method, and an apparatus for evaluating nodes of a funnel model. Techniques of the disclosure can acquire browsing paths of users and store browsing paths offline, so that screened paths of nodes of the funnel model can be screened in parallel when performing online calculation of parameters of nodes of the funnel model to determine parameters of all nodes. Moreover, the screening operation has high operation efficiency, thereby improving the efficiency of evaluating nodes of a funnel model.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Terms of “first,” “second,” “third,” “fourth,” and the like in the specification, claims, and accompanying drawings of the present disclosure are used to differentiate similar objects, rather than describing a particular sequence or order. It should be understood that embodiments of the present disclosure described herein can be implemented in a sequence other than those illustrated or described herein. In addition, tennis of “comprising” and “including,” as well as any variations thereof, are intended to cover a non-exclusive inclusion, for example, a process, method, system, product or apparatus comprising a series of steps or units may not necessarily be limited to those clearly listed steps or units, but may comprise other steps or units that are not clearly listed or are internal to the process, method, product, or apparatus.

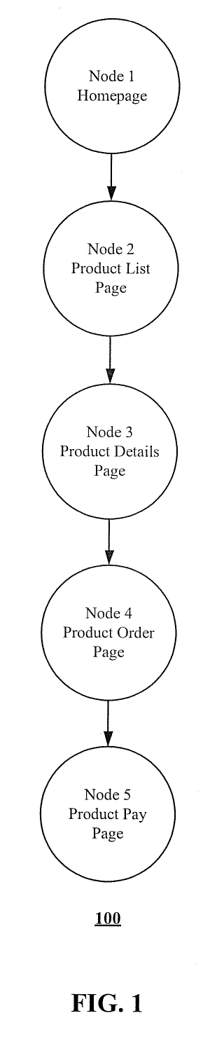

FIG. 1 illustrates a schematic diagram of a funnel model 100, according to embodiments of the disclosure. The funnel model in FIG. 1 includes five nodes.

Node 1 can be associated with a “Homepage.” For example, node 1 can be associated with a page with a URL containing “home.”

Node 2 can be associated with a “Product List Page.” For example, node 2 can be associated with a page directed from the node 1, and with a URL containing “list.”

Node 3 can be associated with a “Product Details Page.” For example, node 3 can be associated with a page directed from the node 1 and the node 2, and with a URL containing “detail.”

Node 4 can be associated with “Product Order Page.” For example, node 4 can be associated with a page directed from the node 1, the node 2, and the node 3, and with a URL containing “order.”

Node 5 can be associated with a “Product Pay Page.” For example, node 5 can be associated with a page directed from the node 1, the node 2, the node 3, and the node 4, and with a URL containing “pay.”

In this example, the browsing sequence of the nodes in the funnel model 100 is the node 1, the node 2, the node 3, the node 4, and the node 5.

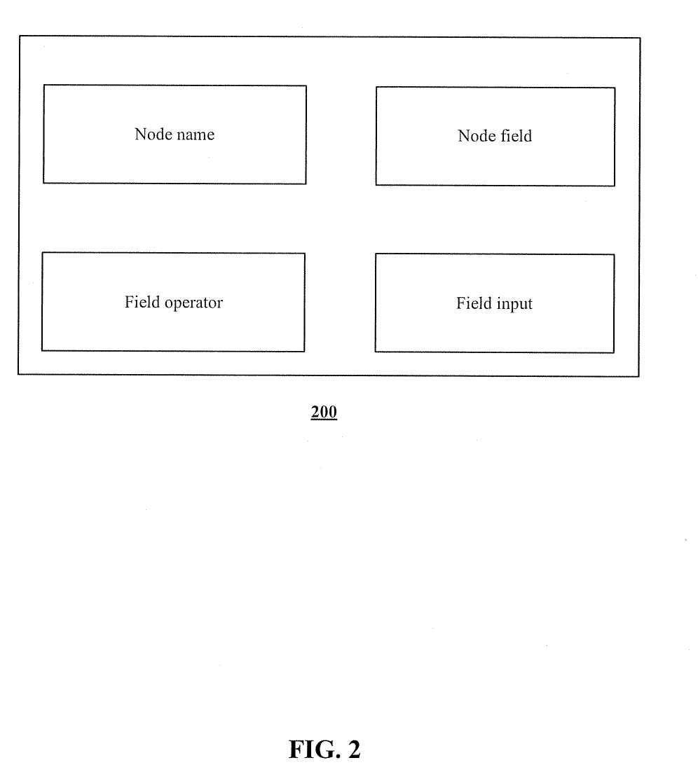

FIG. 2 is a schematic diagram of a node 200, according to embodiments of the disclosure. Node 200 of the funnel model (e.g., funnel model 100 of FIG. 1) can include a node name, a node field, a field operator, and a field input, as shown in FIG. 2. The node name can be used to differentiate different nodes. The node name can include, for example, node 1, node 2, node 3, node 4, node 5, and the like. The node field can be used to designate the field(s), e.g., “URL,” in a browsing record as being associated with the node. The field operator can be used to select an operator for a field associated with a node, such as “=,” “>,” “<,” “>=,” “<=,” “!=,” “like,” “not like.” A user can select one of the operators for one field. The field input can be used to designate an operation object of a field (e.g., the object right to an operator. An exemplary node is shown in Table 1 below.

TABLE 1

| Node Name | Node Field | Field Operator | Field Input |
|---|---|---|---|
| node 1 | URL | “like” | detail |

Table 1 indicates that a user creates a “node 1” and the “node 1” is associated with all webpages in browsing records that have a “URL” field containing “detail.”

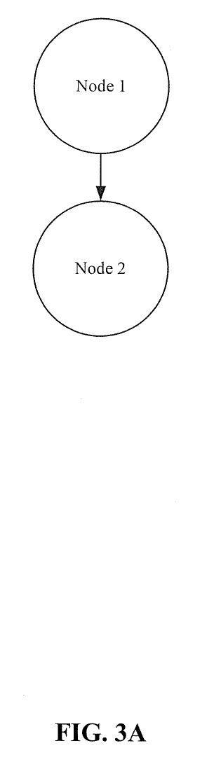

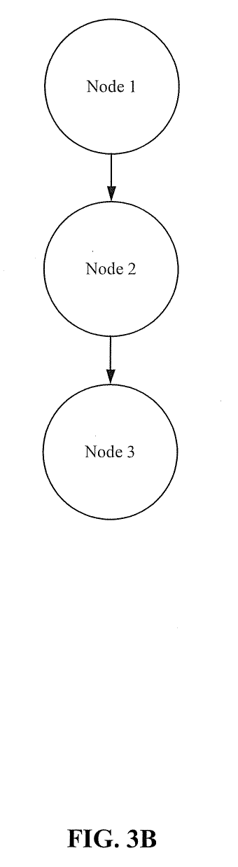

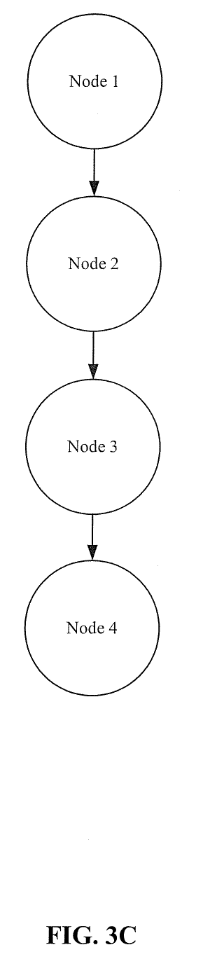

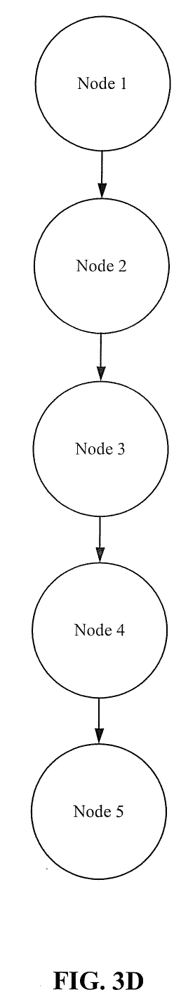

A funnel model can include a starting node (e.g., node 1 of FIG. 1) and a target node. And a screened path corresponding to the target node refers to a path from the starting node to the target node of the funnel model. FIG. 3A illustrates a screened path corresponding to node 2 of FIG. 1, including node 1 and node 2. FIG. 3B illustrates a screened path corresponding to node 3 of FIG. 1, including node 1, node 2, and node 3. FIG. 3C illustrates a screened path corresponding to node 4 of FIG. 1, including node 1, node 2, node 3, and node 4. FIG. 3D illustrates a screened path corresponding to node 5 of FIG. 1, including node 1, node 2, node 3, node 4, and node 5.

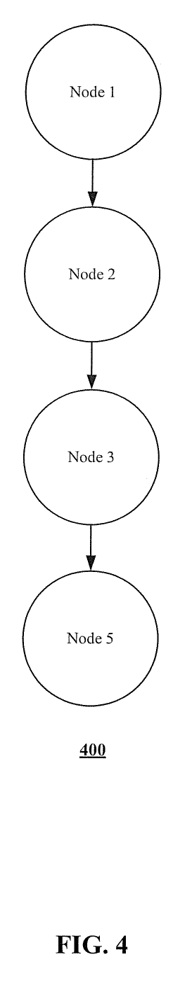

A browsing path can include a screened path corresponding to a node. In some implementations, the screened path is a part of the browsing path. FIG. 4 illustrates a schematic diagram of a browsing path 400, according to embodiments of the disclosure. Browsing path 400 can include a screened path of the node 2 and a screened path of the node 3. In this example, browsing path 400 does not include screened paths of the node 4 or the node 5.

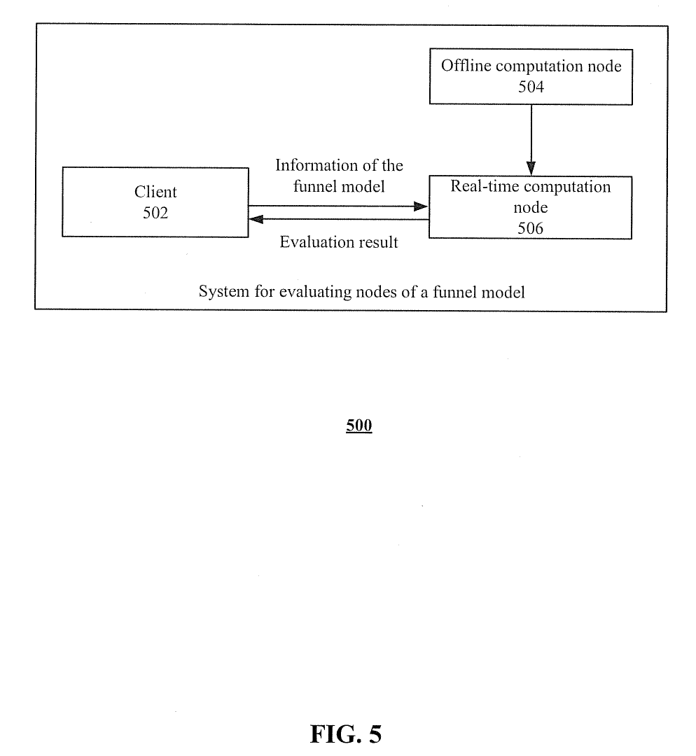

FIG. 5 illustrates a block diagram of an exemplary evaluation system 500 for nodes of a funnel model, according to embodiments of the disclosure. System 500 can include: a client terminal 502, an offline computation node 504, and a real-time computation node 506. Client terminal 502 can be connected with real-time computation node 506, and can be configured to define information of the funnel model and send the information of the funnel model to real-time computation node 506. Offline computation node 504 can be configured to acquire and store browsing paths of users. Real-time computation node 506 can be connected with offline computation node 504 and client terminal 502, and configured to receive the information of the funnel model from client terminal 502, and evaluate nodes of the funnel model according to the information of the funnel model and the browsing paths stored in the offline computation node.

In system 500, offline computation node 504 can be configured to acquire and store browsing paths of users. For example, offline computation node 504 can acquire, according to a user identifier in browsing records, browsing records for each user. The browsing records can include a user identifier, a numbering of a current page, a numbering of a navigation page for the current page, and a page identifier. Offline computation node 504 can also acquire an order of numberings of browsed pages by the user according to the numberings of the current pages and the numberings of navigation pages for the current pages, and acquire a browsing path of the user according to a correspondence relationship between page identifiers and nodes and the order of numberings of browsed pages by the user.

In some embodiments, if the numbering of the current page in a first browsing record of a user is the same as the numbering of a navigation page for the current page in a second browsing record of the user, the offline computation node 504 may determine that the numbering of the current page in the first browsing record is sequentially before the numbering of the current page in the second browsing record.

In some embodiments, real-time computation node 506 is further configured to acquire a screened path corresponding to a target node of the funnel model. The screened path corresponding to the target node is a path from a starting node of the funnel model to the target node. Real-time computation node 506 is also configured to evaluate the target node corresponding to the screened path according to the number of first browsing paths among the browsing paths of all users, where each of the first browsing paths includes the screened path.

In some embodiments, to evaluate the target node corresponding to the screened path, real-time computation node 506 can be configured to determine, according to the number of different users corresponding to the first browsing paths, the number of UV of the target node corresponding to the screened path. In some embodiments, the real-time computation node 506 can be configured to determine, according to the number of the first browsing paths, the number of PV of a browsed page of the target node corresponding to the screened path.

In the system 500, the offline computation node acquires and stores offline browsing paths of users. Upon receiving the information of the funnel model from the client terminal, the real-time computation node evaluates nodes of the funnel model according to the information of the funnel model and the browsing paths of users stored in the offline computation node. Because the browsing paths of users have been acquired and stored offline, when performing online calculation of parameters of each node of the funnel model, screened paths of nodes of the same funnel model and screened paths of nodes of different funnel models can be determined in parallel. In the system 500, when acquiring parameters of nodes of funnel models, the browsing paths of users stored offline can be used repeatedly to determine parameters of each node. Moreover, the screening operation is relatively simple and with high processing efficiency, thereby improving the efficiency of evaluating nodes of a funnel model.

In some embodiments, real-time computation node 506 can be further configured to feed a real-time evaluation result of the funnel model back to the client terminal.

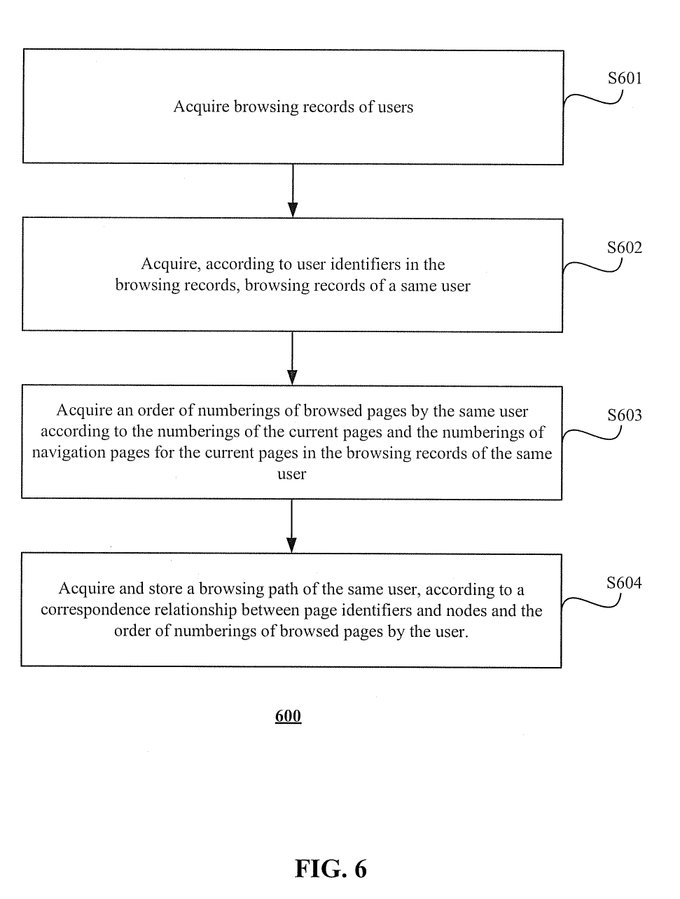

FIG. 6 is a flow chart of a method 600 for acquiring a user browsing path, according to embodiments of the disclosure. For example, method 600 can be implemented by, e.g., system 500 of FIG. 5. The method 600 includes steps S601-S604.

In step S601, browsing records of users can be acquired. The browsing records can include user identifier, a numbering of a current page, a numbering of a navigation page for the current page, and page identifier. The user identifier can be identified by “cookie_ID,” the numbering of the current page can be identified by “page_ID,” the numbering of a navigation page for the current page can be identified by “refer_page_ID,” and the webpage identifier can be identified by a URL.

For example, the browsing records of User A and User B are listed in Table 2 below.

TABLE 2

| | Pages |
|---|---|
| User | (format: page_ID#refer_page_ID#URL, and pages are |
| identifier | separated by a comma) |
| A | 1#-1#home, 3#2#list, 2#1#list |
| B | 3#-1#home, 4#3#list, 8#12#pay, 12#4#detail |

It can be seen from Table 2 that User A has 3 browsing records, including “1#−1#home,” “3#2#list,” and “2#1#list.”

The browsing record “1#−1#home” can indicate that the numbering of the current page is 1, the numbering of a navigation page for the current page is “−1,” indicating no navigation page, and the URL contains “home.”

The browsing record “3#2#list” can indicate that the numbering of the current page is 3, the numbering of a navigation page for the current page is 2, and the URL contains “list.”

The browsing record “2#1#list” can indicate that the numbering of the current page is 2, the numbering of a navigation page for the current page is 1, and the URL contains “list.”

As shown in Table 2, User B has 4 browsing records. The browsing record “3#−1#home” indicates that the numbering of the current page is 3, the numbering of a navigation page for the current page is −1, and URL contains “home.” The browsing record “4#3#list” indicates that the numbering of the current page is 4, the numbering of a navigation page for the current page is 3, and URL contains “list.” The browsing record “8#12#pay” indicates that the numbering of the current page is 8, the numbering of a navigation page for the current page is 12, and URL contains “pay.”

In step S602, according to user identifiers in the browsing records, browsing records of a same user can be acquired. For example, the browsing records of the same user can be identified by the same user identifier.

In step S603, an order of numberings of browsed pages by the same user can be acquired according to the numberings of the current pages and the numberings of navigation pages for the current pages in the browsing records of the same user.

For example, if the numbering of the current page in a first browsing record is the same as the numbering of a navigation page for the current page in a second browsing record, it can be determined that the numbering of the current page in the first browsing record is sequentially before the numbering of the current page in the second browsing record.

With reference back to Table 2, it can be determined that the order of numberings of browsed pages by User A is 1, 2, 3. Similarly, it can be determined that the order of numberings of browsed pages by User B is 3, 4, 12, and 8.

In step S604, a browsing path of the same user can be acquired and stored, according to a correspondence relationship between page identifiers and nodes and the order of numberings of browsed pages by the user. For example, the browsing path can be stored offline.

With reference back to FIG. 1, it can be seen that node 1 corresponds to a page with a page identifier of “home,” node 2 corresponds to a page with a page identifier of “list,” node 3 corresponds to a page with a page identifier of “detail,” and the node 5 corresponds to a page with a page identifier of “pay.”

Therefore, it can be seen that the browsing path of User A is “homepage-list-list,” i.e., “node 1→node 2→node 2.” And the browsing path of User B is “homepage-list-details-pay,” i.e., “node 1→node 2→node 3→node 5.”

By acquiring browsing records of a user, an order of numberings of browsed pages by the user can be acquired according to the numberings of the current pages and the numberings of navigation pages for the current pages in the browsing records. Therefore, a browsing path of the user can be acquired according to a correspondence relationship between page identifiers and nodes and the order of numberings of browsed pages, thereby acquiring a browsing path of each user.

Acquiring a browsing path of a user described in FIG. 6 can be achieved offline and the acquired results can be stored offline, thereby reducing the load of online calculation. Moreover, parallel processing can be performed not only for evaluating different nodes of the same funnel model, but also for evaluating nodes of different funnel models.

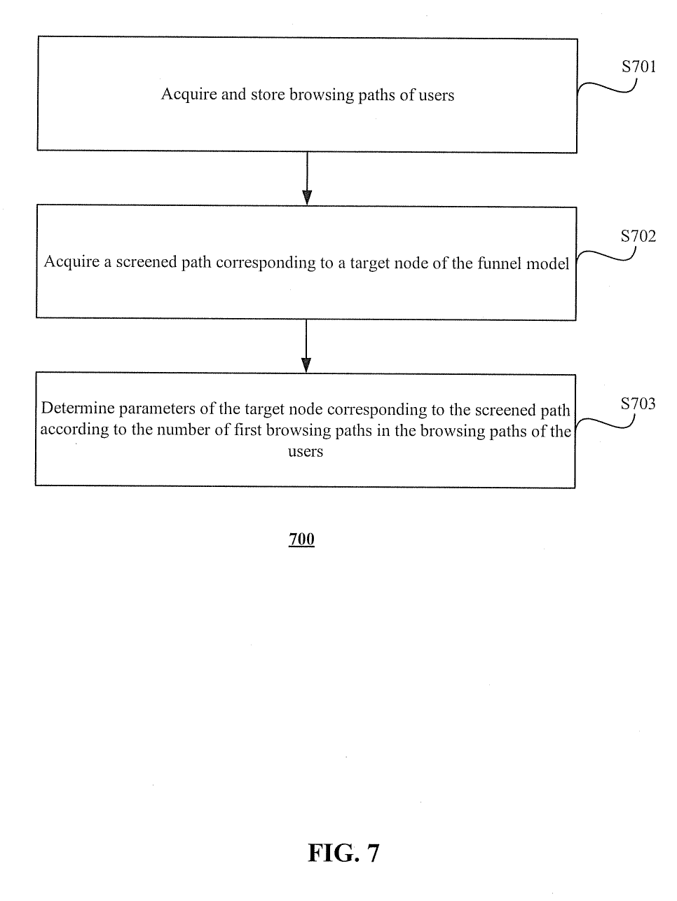

FIG. 7 is a flow chart a method 700 for acquiring parameters of nodes of a funnel model, according to embodiments of the disclosure. For example, method 700 can be implemented by system 500 of FIG. 5. The method 700 may include the following steps.

In step S701, browsing paths of users can be acquired and stored. For example, the browsing paths can be stored offline.

In some embodiments, event tracking can be performed on webpages to collect a browsing record corresponding to each browsing action by a user on the page. Each browsing action by the user for a page can generate a browsing record, and a browsing path of the user is acquired according to the browsing records. In some embodiments, a browsing path of a user can be directly tracked and stored offline. In some embodiments, a browsing path of a user according to an access log of the user can be acquired. It is appreciated that embodiments of acquiring the browsing path are not limited by the disclosure.

In step S702, a screened path corresponding to a target node of the funnel model can be acquired. The target node can be any node in the funnel model, and the screened path corresponding to the target node can be a path from the starting node of the funnel model to the target node.

For example, for the funnel model shown in FIG. 1, the screened paths corresponding to the nodes are shown in FIG. 2 to FIG. 6.

In step S703, parameters of the target node corresponding to the screened path can be determined according to the number of first browsing paths in the browsing paths of the users, where each of the first browsing paths includes the screened path. For example, the first browsing path can be a full screened path, or the screened path is a part of the first browsing path.

The parameters can include the number of UV of users and the number of PV of a browsed page. The number of UV of users and the number of PV of a browsed page of each node of the funnel model are acquired according to the browsing paths of users. For example, according to a number of different users corresponding to the first browsing paths in the browsing paths of all users, the number of UV of the target node corresponding to the screened path can be determined. And according to the number of the first browsing paths in the browsing paths of all, the number of PV of a browsed page of the target node corresponding to the screened path can be determined.

With reference to the browsing paths of User A and User B in Table 2 and the funnel model in FIG. 1, it can be seen that the node 1 has a PV of 2 and a UV of 2, the node 2 has a PV of 2 and a UV of 2, the node 3 has a PV of 1 and a UV of 1, the node 4 has a PV of 0 and a UV of 0, and the node 5 has a PV of 0 and a UV of 0.

In some embodiments, prior to S701, method 700 can further include: receiving, via a real-time computation node, the information of the funnel model from the client terminal, and constructing the funnel model according to the information of the funnel model.

Embodiments of the disclosure acquire browsing paths of users and store the browsing paths offline, acquire a screened path corresponding to a target node of the funnel model, and determine, according to the number of first browsing paths in the browsing paths of users, parameters of the target node corresponding to the screened path. Because the screening of first browsing paths from browsing paths can be performed in parallel for different nodes of the funnel model, and the screening operation is relatively simple with high operation efficiency, the efficiency of acquiring parameters of nodes of a funnel model can be improved.

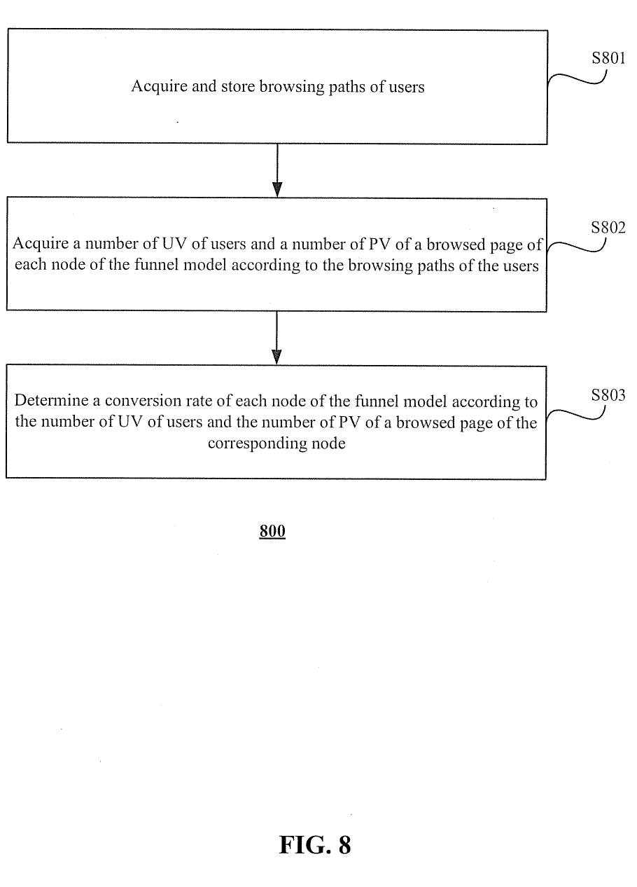

FIG. 8 is a flow chart of a method 800 for obtaining a conversion rate of a node of a funnel model, according to embodiments of the disclosure. For example, method 800 can be implemented by system 500 of FIG. 5. The method 800 may include the following steps.

In step S801, browsing paths of users can be acquired and stored. For example, the browsing paths can be stored offline.

In step S802, the number of UV of users and the number of PV of a browsed page of each node of the funnel model can be acquired according to the browsing paths of the users.

Detailed description of steps S801 and S802 is provided above in connection with FIG. 7, and will not be repeated herein.

In step S803, a conversion rate of each node of the funnel model can be determined according to the number of UV of users and the number of PV of a browsed page of the corresponding node. The conversion rate can include a UV conversion rate and a PV conversion rate. The UV conversion rate can be a ratio of the UV value of the current node to the UV value of the previous node, and the PV conversion rate can be a conversion rate between the PV value of the current node and the PV value of the previous node.

Embodiment of the disclosure can determine a conversion rate of each node of the funnel model according to the UV number of users and the PV number of a browsed page of the each node. When acquiring the UV number of users and the PV number of a browsed page of each node of the funnel model according to the browsing paths of users, the UV number of users and the PV number of browsed pages of nodes can be acquired in parallel in a path screening manner. Moreover, the screening operation is relatively simple with high operation efficiency. Therefore, the efficiency of acquiring the UV number of users and the PV number of a browsed page of each node can be improved, thereby improving the efficiency of obtaining a conversion rate of nodes of a funnel model.

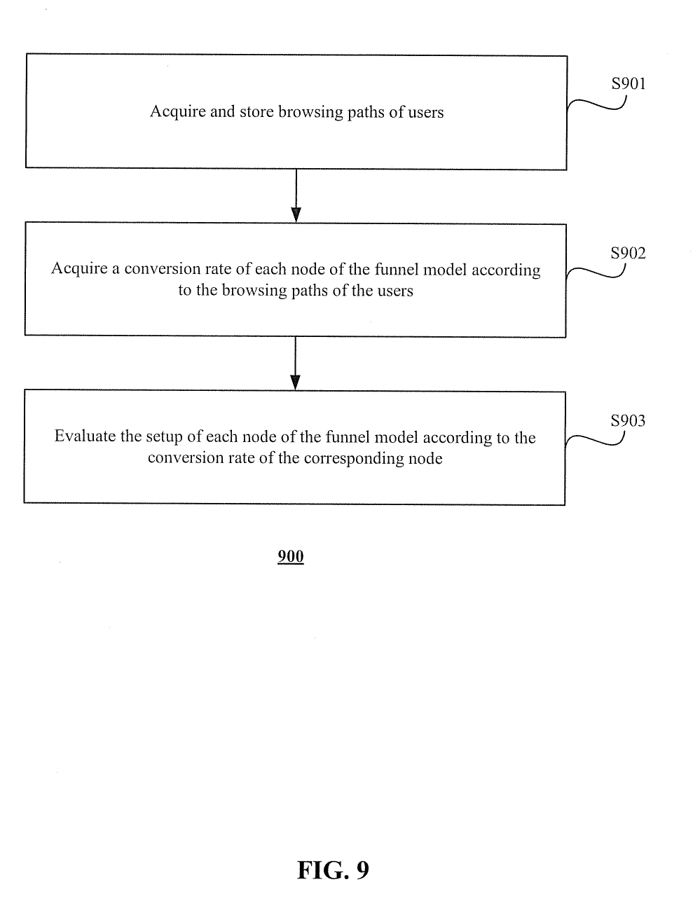

FIG. 9 is a flow chart of a method 900 for evaluating a node of a funnel model, according to embodiments of the disclosure. For example, method 900 can be implemented by system 500 of FIG. 5. The method 900 includes the following steps.

In step S901, browsing paths of users can be acquired and stored. For example, the browsing paths can be stored offline.

In step S902, a conversion rate of each node of the funnel model can be acquired according to the browsing paths of the users.

Detailed description of steps S901 and S902 is provided above in connection with FIG. 7, and will not be repeated herein.

In step S903, the setup of each node of the funnel model can be evaluated according to the conversion rate of the corresponding node. When the conversion rate is higher than a predetermined threshold, the setup of a node can be evaluated to be appropriate. And when the conversion rate is less than the predetermined threshold, the setup of the node can be evaluated to be not appropriate and can be improved.

In some embodiments, method 900 can further include feeding, via a real-time computation node, a real-time evaluation result of the funnel model back to the client terminal.

In some embodiments, system 500 can employ a Spark computing framework. The Spark computing framework has a strong capability for memory operations, which can therefore further improve the computing efficiency.

Conventionally, in an example, with 700 million pieces of PV data, it may take two hours to evaluate a 6-node funnel model and 200 hours to evaluate 100 6-node funnel models when a conventional computation method is used. By the technical solution of the disclosure, with the same 700 million pieces of PV data, it may take 15 minutes for the offline calculation, one minute for online evaluate of a 6-node funnel model or 100 minutes for online evaluate of 100 6-node funnel models. Therefore, the use of the technical solution according to embodiments of the disclosure can improve the efficiency of evaluating nodes of a funnel model.

Embodiment of the disclosure can evaluate whether the setup of each node of the funnel model is appropriate according to the conversion rate of the each node. Because the step of acquiring a conversion rate of each node of the funnel model according to the browsing paths of users can be performed with a high efficiency, the efficiency of evaluating nodes of a funnel model can be improved.

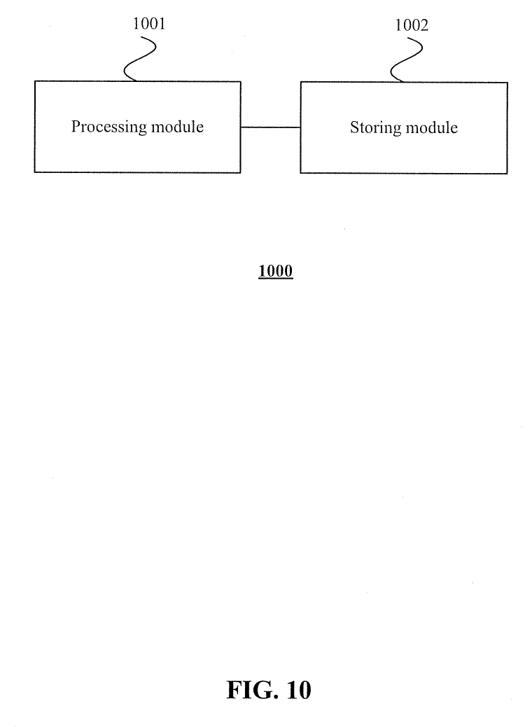

FIG. 10 illustrates a block diagram of an exemplary apparatus 1000 for acquiring a user browsing path, according to embodiments of the disclosure. Apparatus 1000 can include a processing module 1001 and a storing module 1002. Processing module 1001 is configured to acquire browsing records of users. The browsing records can include a user identifier, a numbering of the current page, a numbering of a navigation page for the current page, and a page identifier. Processing module 1001 is further configured to acquire, according to user identifiers in the browsing records, browsing records of each user. Processing module 1001 is further configured to acquire an order of numberings of browsed pages by a user according to the numberings of the current pages and the numberings of navigation pages for the current pages in the browsing records of the user. Processing module 1001 is further configured to acquire a browsing path of a user according to a correspondence relationship between page identifiers and nodes and the order of numbers of browsed pages by the user. Storing module 1002 is configured to store offline the browsing path of the same user.

Apparatus 1000 can be used to implement the method embodiments described above in connection with FIG. 6, which will not be repeated herein.

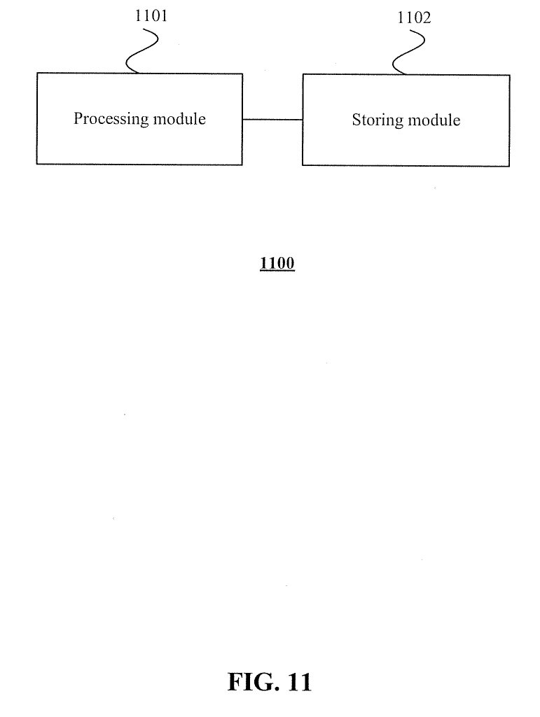

FIG. 11 is a block diagram of an apparatus 1100 for acquiring parameters of nodes of a funnel model, according to embodiments of the disclosure. Apparatus 1100 can include a processing module 1101 and a storing module 1102. Processing module 1101 is configured to acquire browsing paths of users (e.g., all users), storing module 1102 is configured to store the browsing paths of the users (e.g., offline storing). Processing module 1101 is further configured to acquire the number of UV of users and the number of PV of a browsed page of each node of the funnel model according to the browsing paths of the users.

Apparatus 1100 can be used to implement the method embodiments described above in connection with FIG. 7, which will not be repeated herein.

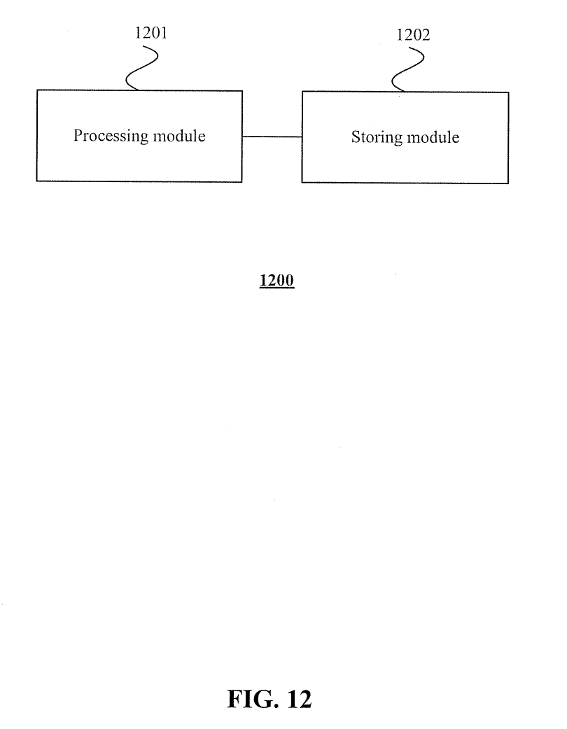

FIG. 12 is a block diagram of an apparatus 1200 for obtaining a conversion rate of a node of a funnel model, according to embodiments of the disclosure. Apparatus 1200 can include a processing module 1201 and a storing module 1202. Processing module 1201 is configured to acquire browsing paths of users (e.g., all users), and storing module 1202 is configured to store the browsing paths of the users (e.g., offline storing). Processing module 1201 is further configured to acquire the number of UV of users and the number of PV of a browsed page of each node of the funnel model, according to the browsing paths of users, and determine a conversion rate of each node of the funnel model according to the number of UV of users and the number of PV of a browsed page of the corresponding node.

The apparatus 1200 can be used to implement the method embodiments described above in connection with FIG. 8, which will not be repeated herein.

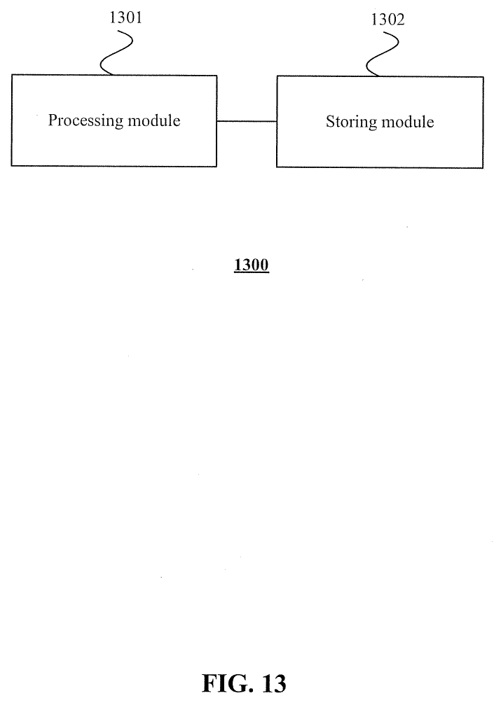

FIG. 13 is a block diagram of an apparatus 1300 for evaluating a node of a funnel model, according to embodiments of the disclosure. Apparatus 1300 can include a processing module 1301 and a storing module 1302. Processing module 1301 is configured to acquire browsing paths of users (e.g., all users), and storing module 1302 is configured to store the browsing paths of the users (e.g., offline storing). Processing module 1301 is further configured to acquire a conversion rate of each node of the funnel model according to the browsing paths of users, and evaluate whether the setup of each node of the funnel model is appropriate according to the conversion rate of the each node.

Apparatus 1300 can be used to implement the method embodiments described above in connection with FIG. 9, which will not be repeated herein.

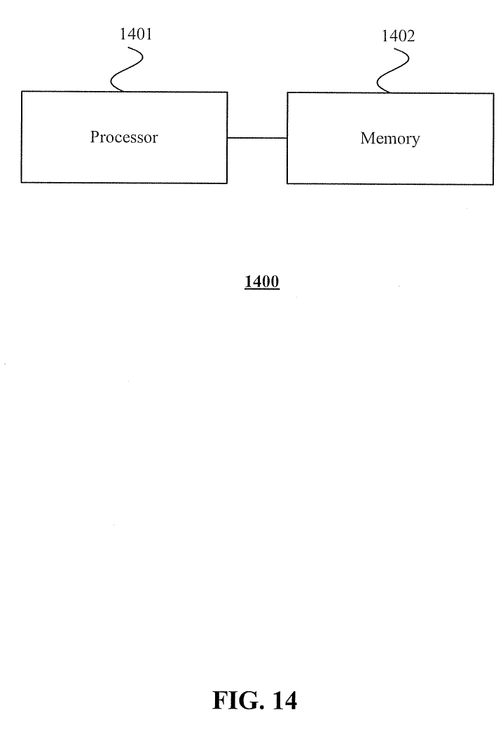

FIG. 14 is a block diagram of an apparatus 1400 for acquiring a user browsing path, according to embodiments of the disclosure. Apparatus 1400 can include a processor 1401 and a memory 1402. Processor 1401 is configured to acquire browsing records of users. The browsing records can include a user identifier, a numbering of the current page, a numbering of a navigation page for the current page, and a page identifier. Processor 1401 is further configured to acquire, according to user identifiers in the browsing records, browsing records of a user. Processor 1401 is further configured to acquire an order of numberings of browsed pages by the user according to the numberings of the current pages and the numberings of navigation pages for the current pages in the browsing records of the user. Processor 1401 is further configured to acquire a browsing path of the user according to a correspondence relationship between page identifiers and nodes and the order of numberings of browsed pages by the user. Memory 1402 is coupled to the processor and configured to store the browsing path of the user. For example, the browsing path can be stored offline.

The apparatus 1400 can be used to implement the method embodiments described above in connection with FIG. 6, which will not be repeated herein.

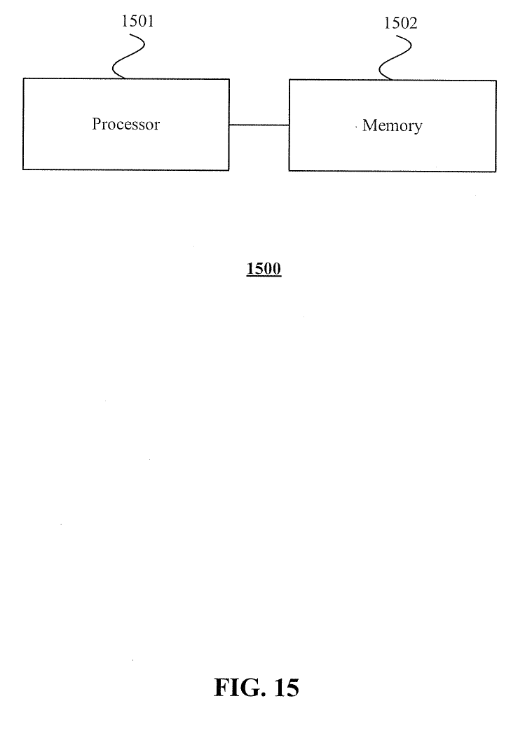

FIG. 15 is a block diagram of an apparatus 1500 for acquiring parameters of nodes of a funnel model, according to embodiments of the disclosure. Apparatus 1500 includes a processor 1501 and a memory 1502. Processor 1501 is configured to acquire browsing paths of users (e.g., all users), memory 1502 is coupled to processor 1501 and configured to store the browsing paths of the users (e.g., offline storing). Processor 1501 is further configured to acquire the number of UV of users and the number of PV a browsed page of each node of the funnel model according to the browsing paths of users.

Apparatus 1500 can be used to implement the method embodiments described above in connection with FIG. 7, which will not be repeated herein.

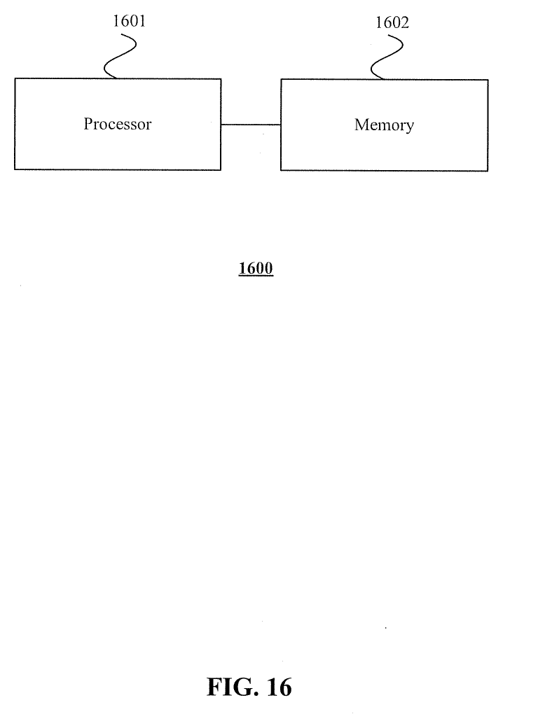

FIG. 16 is a block diagram of an apparatus 1600 for obtaining a conversion rate of a node of a funnel model, according to embodiments of the disclosure. Apparatus 1600 includes a processor 1601 and a memory 1602. Processor 1601 is configured to acquire browsing paths of users (e.g., all users), and memory 1602 is coupled to processor 1601 and configured to store the browsing paths of the users (e.g., offline storing). Processor 1601 is further configured to acquire the number of UV of users and the number of PV of a browsed page of each node of the funnel model according to the browsing paths of users, and determine a conversion rate of each node of the funnel model according to the UV number of users and the PV number of a browsed page of the each node.

Apparatus 1600 can be used to implement the method embodiments described above in connection with FIG. 8, which will not be repeated herein.

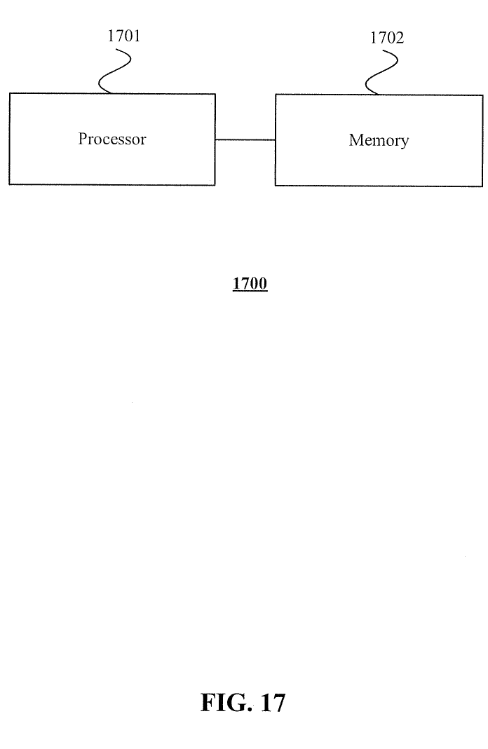

FIG. 17 is a block diagram of an apparatus 1700 for evaluating a node of a funnel model, according to embodiments of the disclosure. Apparatus 1700 can include a processor 1701 and a memory 1702. Processor 1701 is configured to acquire browsing paths of users (e.g., all users), and memory 1702 is configured to store the browsing paths of the users (e.g., offline storing). Processor 1701 is further configured to acquire a conversion rate of each node of the funnel model according to the browsing paths of all users, and evaluate whether the setup of each node of the funnel model is appropriate according to the conversion rate of the corresponding node.

Apparatus 1700 can be used to implement the method embodiments described above in connection with FIG. 9, which will not be repeated herein.

It is appreciated that all or some steps of the above method embodiments can be implemented by a program instructing relevant hardware. The above program can be stored in a computer readable storage medium. When the program is executed, the steps of the above method embodiments are executed, while the storage medium comprises various media capable of storing program codes, such as ROM, RAM, a magnetic disc, an optical disc, and the like.

It is also appreciated that the above embodiments are only used to describe the technical solutions of the present disclosure, rather than limiting the present disclosure. Although the present disclosure has been described in detail with reference to the above embodiments, a person skilled in the art should understand that the technical solutions according to the above embodiments can still be amended, or equivalent substitution can be performed on some or all of the technical features thereof, while these amendments or substitutions do not cause the essence of corresponding technical solutions to depart from the scope of the technical solutions of the embodiments of the present disclosure.

1. A system for evaluating nodes of a funnel model, comprising:
a memory storing a set of instruction; and
at least one processor configured to execute the set of instructions to cause the system to perform:
acquiring browsing records of users, the browsing records including browsing paths of the users; and
performing real-time evaluation on the nodes of the funnel model according to the acquired browsing paths of the users, wherein the acquired browsing paths are stored offline.

2. The system according to claim 1, wherein the browsing records comprise one or more of a user identifier of a user, a numbering of a current page, a numbering of a navigation page for the current page, or a page identifier, and the at least one processor is configured to execute the set of instructions to further cause the system to perform:
acquiring, according to the user identifier of the user in browsing records, browsing records of the user;
acquiring an order of numberings of browsed pages by the user according to the numberings of the current pages and the numberings of navigation pages for the current pages in the browsing records of the user; and
acquiring a browsing path of the user according to the order of numberings of the browsed pages.

3. The system according to claim 2, wherein the browsing records of the user comprise a first browsing record and a second browsing record, and the at least one processor is configured to execute the set of instructions to further cause the system to perform:
determining whether a numbering of the current page in the first browsing record is as same as a numbering of a navigation page for the current page in the second browsing record; and
in response to the determination that the numbering of the current page in the first browsing record is as same as the numbering of the navigation page for the current page in the second browsing record, determining that the number of the current page in the first browsing record is sequentially before the number of the current page in the second browsing record.

4. The system according to claim 1, wherein the funnel model includes a starting node, and the at least one processor is configured to execute the set of instructions to further cause the system to perform:
determining a target node of the funnel model;
acquiring a screened path corresponding to the target node, the screened path being a path from the starting node to the target node; and
evaluating, according to a number of first browsing paths, the target node corresponding to the screened path, wherein each of the first browsing paths comprises the screened path.

5. The system according to claim 4, wherein the at least one processor is configured to execute the set of instructions to further cause the system to perform:
determining, according to a number of different users corresponding to the first browsing paths, a number of unique visitors (UV) of users of the target node; and
determining, according to a number of the first browsing paths in the browsing paths of the users, a number of page views (PV) of a browsed page of the target node.

6. The system according to claim 5, wherein the at least one processor is configured to execute the set of instructions to further cause the system to perform:
determining a conversion rate of the target node according to the number of UV and the number of PV.

7-8. (canceled)

9. A method for evaluating nodes of a funnel model, comprising:
acquiring browsing records of users, the browsing records including browsing paths of the users; and
performing real-time evaluation on the nodes of the funnel model according to the acquired browsing paths of the users,
wherein the acquired browsing paths are stored offline.

10. The method according to claim 9, wherein the browsing records comprise one or more of a user identifier of a user, a numbering of a current page, a numbering of a navigation page for the current page, or a page identifier, and the method further comprises:
acquiring, according to the user identifier of the user in browsing records, browsing records of the user;
acquiring an order of numberings of browsed pages by the user according to the numberings of the current pages and the numberings of navigation pages for the current pages in the browsing records; and
acquiring a browsing path of the user according to the order of numberings of the browsed pages.

11. The method according to claim 10, wherein the browsing records of the user comprise a first browsing record and a second browsing record, and the method further comprises:
determining whether a numbering of the current page in the first browsing record is as same as a numbering of a navigation page for the current page in the second browsing record; and
in response to the determination that the numbering of the current page in the first browsing record is as same as the numbering of the navigation page for the current page in the second browsing record, determining that the number of the current page in the first browsing record is sequentially before the number of the current page in the second browsing record.

12. The method according to claim 9, wherein the funnel model includes a starting node, and the method further comprises:
determining a target node of the funnel model;
acquiring a screened path corresponding to the target node, the screened path being a path from the starting node to the target node; and
evaluating, according to a number of first browsing paths, the target node corresponding to the screened path, wherein each of the first browsing paths comprises the screened path.

13. The method according to claim 12, further comprising:
determining, according to a number of different users corresponding to the first browsing paths, a number of unique visitors (UV) of users of the target node corresponding to the screened path; and
determining, according to a number of the first browsing paths in the browsing paths of the users, a number of page views (PV) of a browsed page of the target node.

14. The method according to claim 13, further comprising:
determining a conversion rate of the target node according to the number of UV and the number of PV.

15. (canceled)

16. The method according to claim 9, further comprising:
feeding a result of the real-time evaluation to a client terminal.

17. A non-transitory computer readable medium that stores a set of instructions that is executable by at least one processor of a computer system to cause the computer system to perform a method for evaluating nodes of a funnel model, the method comprising:
acquiring browsing records of users, the browsing records including browsing paths of the users; and
performing real-time evaluation on the nodes of the funnel model according to the acquired browsing paths of the users,
wherein the acquired browsing paths are stored offline.

18. The non-transitory computer readable medium according to claim 17, wherein the browsing records comprise one or more of a user identifier of a user, a numbering of a current page, a numbering of a navigation page for the current page, or a page identifier, and the set of instructions is executed by the at least one processor of the computer system to cause the computer system to further perform:
acquiring, according to the user identifier of the user in browsing records, browsing records of the user;
acquiring an order of numberings of browsed pages by the user according to the numberings of the current pages and the numberings of navigation pages for the current pages in the browsing records; and
acquiring a browsing path of the user according to the order of numberings of the browsed pages.

19. The non-transitory computer readable medium according to claim 18, wherein the personal browsing records of the user comprise a first browsing record and a second browsing record, and the set of instructions is executed by the at least one processor of the computer system to cause the computer system to further perform:
determining if a numbering of the current page in the first browsing record is as same as a numbering of a navigation page for the current page in the second browsing record; and
in response to the determination that the numbering of the current page in the first browsing record is as same as the numbering of the navigation page for the current page in the second browsing record, determining that the number of the current page in the first browsing record is sequentially before the number of the current page in the second browsing record.

20. The non-transitory computer readable medium according to claim 17, wherein the funnel model includes a starting node, and the set of instructions is executed by the at least one processor of the computer system to cause the computer system to further perform:
determining a target node of the funnel model;
acquiring a screened path corresponding to the target node, the screened path being a path from the starting node to the target node; and
evaluating, according to a number of first browsing paths, the target node corresponding to the screened path, wherein each of the first browsing paths comprises the screened path.

21. The non-transitory computer readable medium according to claim 20, wherein the set of instructions is executed by the at least one processor of the computer system to cause the computer system to further perform:
determining, according to a number of different users corresponding to the first browsing paths, a number of unique visitors (UV) of users of the target node; and
determining, according to the number of the first browsing paths in the browsing paths of the users, a number of page views (PV) of a browsed page of the target node.

22. The non-transitory computer readable medium according to claim 21, wherein the set of instructions is executed by the at least one processor of the computer system to cause the computer system to further perform:
determining a conversion rate of the target node according to the number of UV and the number of PV.

23. (canceled)

24. The non-transitory computer readable medium according to claim 17, wherein the set of instructions is executed by the at least one processor of the computer system to cause the computer system to further perform:
feeding a result of the real-time evaluation to a client terminal.
